(19) United States
(12) Patent Application Publication
(10) Pub. No.: US 2013/0161851 A1
(43) Pub. Date: Jun. 27, 2013

(54) METHOD AND APPARATUS FOR DETECTING GLASS BREAKAGE DURING A PROCESS FOR ENCAPSULATING A TEMPERED GLASS PANEL

(71) Applicant: Pilkington Group Limited, Nr. Ormskirk (GB)

(72) Inventors: Michael R. Ehrick, Toledo, OH (US); Robert R. Frutig, Perrysburg, OH (US)

(73) Assignee: Pilkington Group Limited, Nr. Ormskirk (GB)

(21) Appl. No.: 13/716,429

(22) Filed: Dec. 17, 2012

Related U.S. Application Data
(60) Provisional application No. 61/578,908, filed on Dec. 22, 2011.

(51) Int. Cl. C03C 17/00

(52) U.S. Cl. CPC C03C 17/001
USPC 264/40.1; 425/135

(57) ABSTRACT

An apparatus which accurately detects breakage of a tempered glass panel in an encapsulation die during a glass encapsulation process and rapidly reacts to the detection of such breakage to interrupt the encapsulation process, thus minimizing damage to the encapsulation die, and by so doing, reducing process downtime. A method of utilizing the apparatus is also a part of the invention.

### RELATED APPLICATION

This application is claiming the benefit, under 35 U.S.C. 119(e), of the provisional application filed Dec. 22, 2011 under 35 U.S.C. 111(b), which was granted Ser. No. 61/578,908. This provisional application is hereby incorporated herein by reference in its entirety.

### BACKGROUND OF THE INVENTION

The invention relates to an apparatus and a method for utilizing the apparatus to detect glass breakage during a tempered glass encapsulation process. More specifically, this general process objective is accomplished by an apparatus which accurately detects breakage of a tempered glass panel in an encapsulation die, and rapidly reacts to the detection of such breakage to interrupt the encapsulation process, thus minimizing damage to the encapsulation die and, by doing so, reducing process downtime. The method of utilizing the apparatus for the intended purposes is also part of the invention.

Encapsulation for purposes of this application is a process of molding a polymeric member onto a portion, typically a peripheral portion, of a glass sheet, preferably a vehicle window.

In-process inspection systems are known in the patent literature, for example:

U.S. Pat. No. 4,957,670 describes a plastic injection molding/encapsulation apparatus for the peripheral encapsulation of a glass workpiece which is equipped with an optical sensing device including a light source, a light detector, and a light reflector to detect possible glass breakage of the workpiece and thus automatically shut down the plastic injection process to avoid damage to the mold.

U.S. Pat. No. 5,266,806 describes a method and apparatus for determining the transmission capability of a substrate and any damage which may affect the transmission capability by directing a focused infrared illumination beam through the substrate and observing the reflected or scattered light to detect any scratch, fracture, blemish or the like, in the substrate surface or within the substrate itself, by detecting any change in the energy level of the sensed beam or change in reflected scattered light. The illumination beam is said to provide a spot on the substrate surface and by mapping an entire substrate of said spots adjacent one another and comparing the energy or light level of adjacent spots, any internal or external damage can be determined.

U.S. Pat. No. 5,619,995 describes a system and method for combining diagnostic digital motion video acquisition, display, and processing with physiological data indexing through utilization of techniques of digital motion video compression through domain transformation. Among other things, one component of the system implements real-time video frame indexing with one or more physiological timing event markers or physiological signals.

U.S. Pat. No. 6,650,703 describes an image transmitting remote object examination device including: (a) an image-recording system at the location of the object to be examined; (b) an observation station located at a distance from the image-recording system for the evaluation of the image and for the remote control of the image-recording system; (c) an intervening narrow band telecommunications link, by way of which the images taken are transferred to the observation station using image data compression and/or reduction together with remote control commands to the image system. A system status-determining unit continuously records the overall system status.

U.S. Pat. No. 7,369,240 describes an apparatus and method for the real-time inspection for defects in and on transparent sheets, such as sheets of glass. A sensor detects a transparent light reflective coating on the transparent sheet and defines a sample profile. An optical inspection system utilizes an illumination source and an imaging device to obtain images of the transparent sheets. An image processing system analyzes for defects in the transparent sheets, including coating defects and defects in edge deleted perimeters of the transparent sheets. Inspection variables which correspond to the sample profile are used by the optical inspection system and image processing system for real-time inspection.

U.S. Pat. No. 7,868,291 describes a method and apparatus for investigating the condition of a glazing panel, including using a viewing device to view an illuminating electromagnetic radiation profile at a target zone of the glazing panel, wherein data relating to the viewed radiation profile is compared to other data to produce an output related to the condition of the glazing panel at the target zone.

While other methods could be used, typically, and preferably, the method of primary interest in connection with the invention of the application utilizes a two-part encapsulation die made from a metal material. Typically, each part of the two-part encapsulation die includes one or more molding cavities, although other configurations are possible. In a typical process, a glass panel is disposed in a precisely predetermined position in the molding cavity. The two parts of the encapsulation die are brought into intimate contact and are secured to withstand the pressures of the encapsulation process. One or more polymeric materials are injected into preformed channels in the encapsulation die, such channels being located proximate those portions of the glass panel onto which the polymeric material is to be molded, in the shape of the preformed channel.

While such encapsulation processes are known, no chemical/mechanical process is error-proof. Among the problems known to occur is the breakage of the glass panel during the encapsulation process. Such breakage can occur for a variety of reasons. Some typical reasons include: (1) improper positioning in the molding cavity; (2) variation in glass configuration beyond that which can be accommodated in the encapsulation process; (3) a flaw in the glass panel and the like. Of course, when subjected to the pressures of the encapsulation process, any of these conditions can result in breakage of the glass panel.

In known systems, despite breakage of the glass panel, the process would proceed to completion. When the two parts of the encapsulation die are then opened to remove the glass panel, the glass panel is clearly worthless, and typically pieces of glass will have fallen into the at least one molding cavity. At best, the encapsulation process will have to be interrupted for the broken glass to be very thoroughly removed from the molding cavity. In more serious situations, it is found that glass pieces have been forced against what is typically a highly polished/precisely machined surface of the molding cavity, possibly causing scratches or other damage to such surfaces, thus rendering the die temporarily unusable. Such encapsulation dies are typically quite expensive, and of course, interruption of the manufacturing process for any significant time is very costly.

Therefore, it would be advantageous to have a means to minimize the damage to the molding surfaces of the encapsulation die, and reduce process downtime when glass breakage in the encapsulation die does occur, as it inevitably will.

### SUMMARY OF THE INVENTION

The invention relates to an apparatus and a method for utilizing same to detect glass breakage during the course of a tempered glass encapsulation process. More specifically, this general process objective is accomplished by an apparatus which accurately detects breakage of a tempered glass panel in an encapsulation die during the glass encapsulation process, and rapidly reacts to the detection of such breakage to interrupt the encapsulation process, thus minimizing damage to the encapsulation die, and by doing so, reducing process downtime. A method of utilizing the apparatus is also a part of the invention.

More particularly, the invention relates to an apparatus which utilizes one or more video devices capable of recording at least one, and preferably a continuous series of, relatively high resolution visual images of a glass panel disposed in at least one molding cavity in the encapsulation die during the encapsulation process, and one or more light sources to illuminate a portion of the glass panel, preferably a light transmitting portion of the glass panel. Both the video device and the light source are disposed in the encapsulation die, which apparatus is connected by conventional electronic means to a computer containing dedicated software which software is capable of high-speed, real-time analysis of the images recorded by the one or more video devices. If analysis of the images indicates breakage of the glass panel, the computer transmits an electronic signal to a process control device which is capable of interrupting the encapsulation process, preferably within a tenth of a second or less.

Generally, the method of the invention includes:
disposing a tempered glass panel in a molding cavity formed in one part of a two-part encapsulation die having at least one video device and at least one light source disposed therein;
bringing the two parts of the encapsulation die into intimate contact to form an encapsulation chamber;
activating the at least one video device and the at least one light source, so that the light source preferably illuminates a light transmitting portion of the glass panel to a level sufficient for the at least one video device to record one or more images, preferably a continuous series of images, of the glass panel;
initiating injection of one or more polymeric materials into desired portions of the encapsulation chamber so that the polymeric material is directed into molding contact with the desired portion of the glass panel;
transmitting the one or more images of the glass panel in electronic form to a computer containing dedicated software for analyzing such images, wherein:
if the encapsulation process proceeds normally, the images of the glass panel transmitted to the computer are analyzed in real time and are stored for information or may be discarded;
alternatively, if the glass panel breaks during the encapsulation process, the images showing such breakage are analyzed in real-time by the dedicated software, and an electronic signal indicating such nearly instantaneous occurrence of breakage is transmitted to a process control device which interrupts the encapsulation process within a tenth of a second or less;
removing the broken glass panel from the encapsulation die;
cleaning any glass fragments or other residual material from the encapsulation die; and
readying the encapsulation die for loading of a new glass panel.

In a preferred embodiment, the at least one video device and the at least one light source are both disposed in one part of the two-part encapsulation die, and when the two parts of the encapsulation die are brought into intimate molding contact, preferably diffuse light is transmitted from the at least one light source, in substantial part, through a light transmitting portion of the glass panel, the light is reflected off a diffusely reflective paint disposed on a predetermined portion of the other part of the two-part encapsulation die. The reflected light is detected by the at least one video device, which records at least one image, but preferably a continuous series of images of the glass panel, close in time to one another.

### BRIEF DESCRIPTION OF THE DRAWINGS

The above, as well as other advantages of the present invention, will become readily apparent to those skilled in the art from the following detailed description when considered in the light of the accompanying drawings in which:

FIG. 1 is a schematic cross-sectional view of the apparatus in connection with a first embodiment of the invention.

FIG. 2 is a schematic cross-sectional view of the apparatus in connection with a second embodiment of the invention.

FIG. 3 is a perspective view of a typical two-part encapsulation die in which the apparatus of the invention might be deployed.

FIG. 4 shows the two-part encapsulation die of FIG. 3 with an unbroken tempered glass panel disposed therein as it would be “seen” by the at least one video device according to the invention.

FIG. 4a shows the two-part encapsulation die of FIG. 3 wherein the tempered glass panel has broken during the encapsulation process as would be detected by the at least one video device according to the invention.

FIG. 5 is a schematic cross-sectional view of a variation of the first embodiment of the invention where the light source and the video device are in a non-normal relationship to the tempered glass panel.

### DETAILED DESCRIPTION OF THE INVENTION

The invention relates to an apparatus and method for utilizing same to affect the course of a tempered glass encapsulation process. More specifically, this general process objective is accomplished by an apparatus 10 which accurately detects breakage of a tempered glass panel 12 in an encapsulation die 14 during the glass encapsulation process, and rapidly reacts to the detection of such breakage to interrupt the encapsulation process, thus minimizing damage to the encapsulation die 14 and, by doing so, reducing process downtime. A method of utilizing the apparatus 10 is also a part of the invention.

While the invention may be used with any conventional injection molding process, a preferred process involves placing a tempered sheet of glass 12, or a vehicle glazing formed from a tempered sheet of glass, into a first part of a two-part encapsulation die 14, typically having a moving part 16 and a stationary part 18, made to precisely position the glass 12 in the encapsulation die 14, including having an area coinciding with at least a portion of the periphery of the glass sheet. The defined area constitutes a portion of a molding cavity 20 formed in one or more of the moving and stationary part(s) (16,18) of the encapsulation die 14 that is capable of receiving a polymeric material in a flowable form upon injection into the encapsulation die 14. Typically, a second complementary part (i.e. one of the moving part and the stationary part (16,18)) of the encapsulation die 14 is brought into intimate contact with the first part of the encapsulation die, the first and second parts together forming an encapsulation chamber 22 which takes the three dimensional form of the profile of the polymeric member that is to be bonded to the tempered glass panel 12. A sufficient quantity of the liquid polymeric material is injected to fill the encapsulation chamber 22, through one or more injection points and, in doing so, comes into bonding contact with the periphery of the tempered glass sheet 12. Upon cooling for a sufficient time, the tempered glass panel 12 with the solidified polymeric member molded onto it can be removed from the mold in a form ready for use/storage/transport. Typically, each mold part (16,18) is formed from a metal, preferably steel or aluminum.

Into a recess formed in at least one part of the just-described encapsulation die 14, at least one video device 24 is disposed and oriented so as to be able to record images of at least a portion of the tempered glass panel 12 as it is positioned in the encapsulation die 14. Preferably, the at least one video device 24 is a miniature video camera, for example fitting within a cube 15 to 25 mm on each edge, as is known to those skilled in the art. Preferably, the video camera is a monochrome camera. It is within the scope of the invention that two or more video devices 24 may be disposed in predetermined locations in the encapsulation die 14, if desired. Other types of video devices may also be useful in connection with the invention.

Similarly, at least one light source 26 is disposed in a recess formed in the encapsulation die 14 and oriented so as to illuminate a portion of the tempered glass sheet 12 within the field of view of the at least one video device 24 to record one or more images 28 of the glass sheet 12.

Preferably, the at least one light source 26 is a LED light desirably having a rating of between 500 milli-candela (mcd) and 10,000 mcd and a dominant wavelength between 380 nm and 1050 nm, preferably 380 nm to 410 nm. For some applications two or more light sources 26 are preferably disposed in predetermined locations in the encapsulation die 14. In some embodiments, the at least one light source 26 is equipped with an optical device, for example a diffusing element 30, capable of diffusing the light beams emitted by the at least one light source. A suitable diffusing element 30 may be made from, for example, a ground glass plate and an “opal glass” plate. For some applications of the invention, it may be desirable to insert a so-called dispersing lens 32, preferably having a double concave configuration, between the at least one light source 26 and the diffusing element 30.

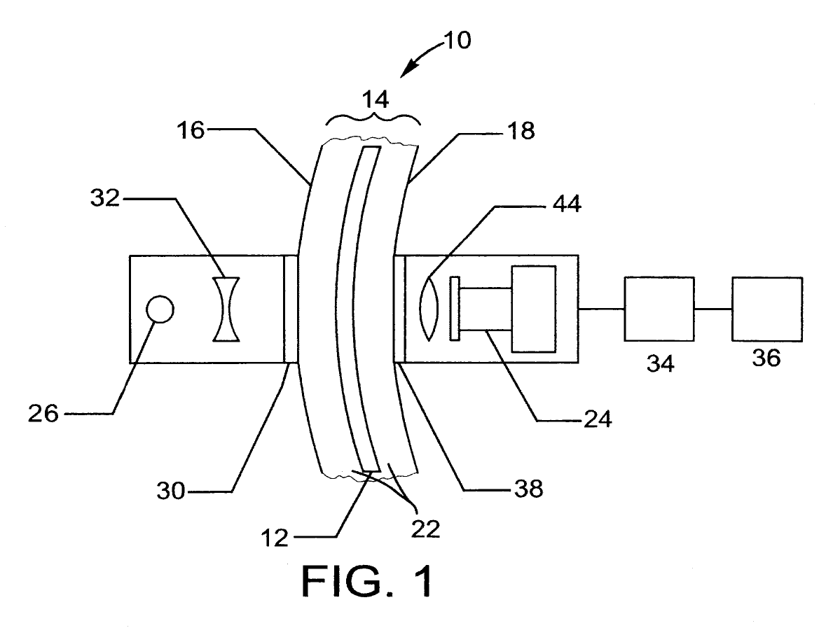

An embodiment of the invention as shown in FIG. 1, the at least one video device 24 is disposed in one of the movable or stationary part (16,18) of the two-part encapsulation die 14, and the at least one light source 26 is disposed in the other of the movable or stationary part (16,18) of the two-part encapsulation die 14.

The at least one image 28 of the tempered glass panel 12 recorded by the at least one video device 24 may be electronically transmitted by any suitable conventional means to a computer 34 having installed therein dedicated software for analysis of the at least one image 28 of the glass panel 12 recorded by the at least one video device 24. Preferably, the at least one video device 24 records a continuous series of images 28 of the glass panel 12 in the encapsulation die 14, the images 28 taken close in time to one another. The dedicated software is capable of at least real-time analysis of such continuous series of images 28 of the glass panel 12, recognizing breakage of the tempered glass panel 12, and nearly instantaneous transmittal of electronic signals by any suitable conventional means to an encapsulation process control device 36 if an indication of the breakage of the tempered glass panel 12 is received by the dedicated software. Such transmitted electronic signals to the encapsulation process control device 36 may be in the form of a command to abort the encapsulation process.

In a particularly preferred configuration of any of the embodiments of the invention, multiple encapsulation chambers 22 may be formed in the encapsulation die 14. In such a configuration, it is preferred that at least one video device 24 and at least one light source 26 are disposed at predetermined locations in the encapsulation die 14 so as to be able to monitor a tempered glass panel 12 disposed in each of the multiple encapsulation chambers 22.

In a preferred form of any of the embodiments of the invention, the at least one video device 24 is capable of recording the continuous series of images 28 of the tempered glass panel 12 in the encapsulation die 14 at a rate on the order of at least 25 images/second. In turn, the computer 34 and dedicated software of the invention are capable of analyzing the images 28 at such a rate on a real-time basis, and in doing so is able to detect any sudden changes in the appearance of the glass panel 12, for example, if breakage of the tempered glass panel 12 should occur.

A method of utilizing the apparatus 10 of the invention, the primary components of which have previously been described herein, will now be discussed.

In a preferred method of utilizing the apparatus 10, a tempered glass panel 12, preferably a tempered glass vehicle window, is disposed in one of a movable part 16 or a stationary part 18 of a two-part encapsulation die 14, having at least one molding cavity 20 formed therein. At least one video device 24 and at least one light source 26 are disposed in one or more of the movable part 16 and the stationary part 18 of the encapsulation die 14. The movable part 16 and the stationary part 18 of the encapsulation die 14 are brought into intimate contact by any suitable mechanism to form at least one encapsulation chamber 22.

The at least one video device 24 is activated and the at least one light source 26 is illuminated so that the at least one light source 26 illuminates the tempered glass panel 12 to a level of illumination sufficient for the at least one video device 24 to record one or more images 28, preferably high resolution images, of the tempered glass panel 12 in the at least one encapsulation chamber 22.

Injection of one or more polymeric materials into desired portions of the at least one encapsulation chamber 22 is initiated, so that the one or more polymeric materials are directed into molding contact with one or more desired portions of the tempered glass panel 12, so as to form a molded polymeric member on at least a portion of the periphery of the tempered glass panel 12.

As the encapsulation process proceeds, the at least one video device 24 records one or more images of the tempered glass panel 12, and preferably a continuous series of images 28 close in time to one another, for example, at least 25 images per second. Generally, the at least one video device 24 records at least one reference image of the glass panel 12 in an intact condition.

The recorded images 28 are nearly instantaneously transmitted electronically to a computer 34 having dedicated software installed therein. The recorded images 28 are analyzed on a real-time basis to detect any sudden changes in the appearance of the tempered glass panel 12. As is generally known, tempered glass is intended to break into many small, harmless glass particles, rather than large, potentially dangerous glass shards, which can result when annealed glass breaks. The cracks which define the periphery of the small glass particles of a broken tempered glass panel 12 have a 95% or greater chance of being detected in the images 28 recorded by the at least one video device 24 if the field of view of the at least one video device 24 is about 500 mm² or greater, for example, a circle about 25 mm in diameter or a rectangle about 19 mm×26 mm.

If no such sudden changes in the appearance of the tempered glass panel 12 are detected, the recorded images 28 are stored or discarded, the encapsulation process is completed, and the two parts (16,18) of the encapsulation die 14 are moved apart. A tempered glass panel 12, preferably a vehicle window, having a polymeric member molded thereon is removed from the encapsulation die 14, and a new tempered glass panel 12 is disposed in the encapsulation die 14.

If, however, such sudden change in appearance of the tempered glass panel 12 is detected in the analysis of the recorded images 28 of the tempered glass panel 12 by the dedicated software, an electronic signal is nearly instantaneously transmitted to the encapsulation process control device 36, which upon receipt of the electronic signal from the computer 34, nearly instantaneously aborts the encapsulation process. The elapsed time from detection of the tempered glass panel 12 being broken to interruption of the encapsulation process is 0.1 sec. or less, preferably 0.04 sec or less, and more preferably 0.02 sec or less. By way of reference, a typical encapsulation cycle may be on the order of 3 sec. While other methods of removing broken pieces of glass from the molding cavity 20 and thoroughly cleaning the molding cavity 20 may be possible, typically such operations are performed manually, and perhaps only after damage to the mold results.

The apparatus 10 of the invention may be capable of operating in a manner similar to that just described, but capable of detecting glass breakage even before the two mold parts (16,18) are brought into complete, intimate molding contact.

As has been previously described herein, an encapsulation die 14 may include multiple molding cavities 20 forming multiple encapsulation chambers 22 when the two encapsulation die parts (16,18) are in intimate molding contact. It may be desirable to utilize the apparatus 10 of the invention to monitor the condition of a tempered glass panel 12 in each such encapsulation chamber 22 by at least one video device 24 and at least one light source 26 properly oriented to do so. Typically, the encapsulation process is initiated simultaneously for each of the tempered glass panels 12. Thus, it is possible that multiple continuous series of recorded images 28 (at least one continuous series of images 28 for each glass panel 12) at a rate of, for example, 25 images/sec. are transmitted to the computer 34 containing the dedicated software, all to be analyzed in real-time by the computer 34 and dedicated software. It is an aspect of the invention for such high speed analysis to be achieved thereby, and an aspect which makes the invention particularly applicable in a high-volume glass manufacturing operation.

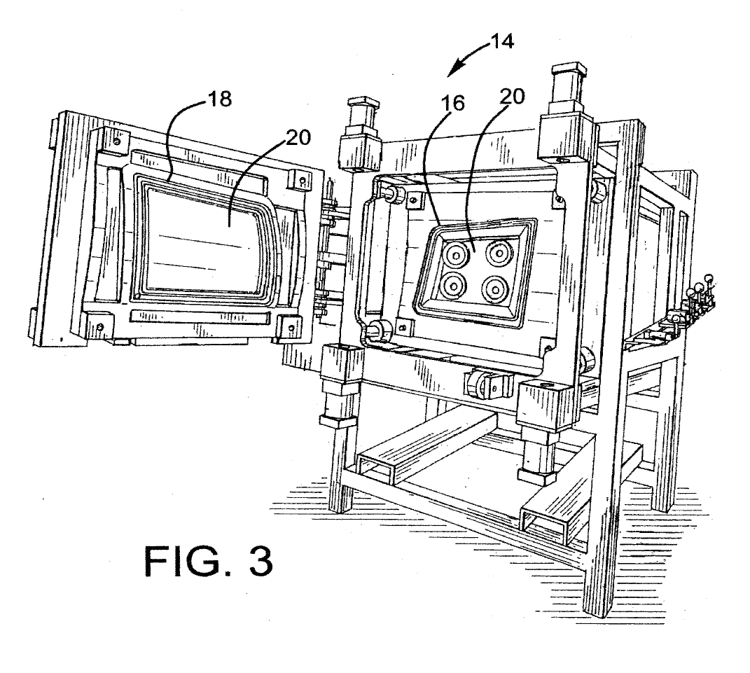

FIG. 1 shows a first embodiment of the apparatus 10 of the invention disposed in a typical two-part encapsulation die 14, as shown in greater detail in FIG. 3. As shown, the at least one video device 24 is disposed in either the movable part 16 or the stationary part 18 of the encapsulation die 14. The viewing area formed in the encapsulation die 14 through which the at least one video device 24 “views” the tempered glass panel 12 may be closed by, for example, a cover made from quartz, sometimes known as a quartz “window” 38, which protects the at least one video device 24 from the harsh environment of the encapsulation chamber 22 during the encapsulation process, while being durable and allowing a high definition view of the tempered glass panel 12. In a complementary way, the at least one light source 26 is disposed in the other of the movable part 16 and stationary part 18 than the one in which the at least one video device 24 is disposed. Again, by way of example, a quartz window 38 closes the opening in the encapsulation die 14 behind which the at least one light source 26 is located. This is again for purposes of protecting the at least one light source 26. Various optical elements, for example, diffusing elements 30, polarizing filters, lenses, for example a double-convex “close-up” lens 44 to facilitate extremely close focus, and the like may be located between the light source 26, the video device 24 and their respective quartz windows 38. In the embodiment shown in FIG. 1, when a tempered glass panel 12 is disposed in the encapsulation die 14, and the two mold parts (16,18) are brought into intimate contact to form an encapsulation chamber 22, the at least one video device 24, and the at least one light source 26 are on opposite sides of the tempered glass panel 12, and located so that the light emitted by the at least one light source 26 illuminates a predetermined substantially transparent portion of the tempered glass panel 12, to a level sufficient for the at least one video device 24 to detect and record one or more images 28 of the illuminated portion of the tempered glass panel 12.

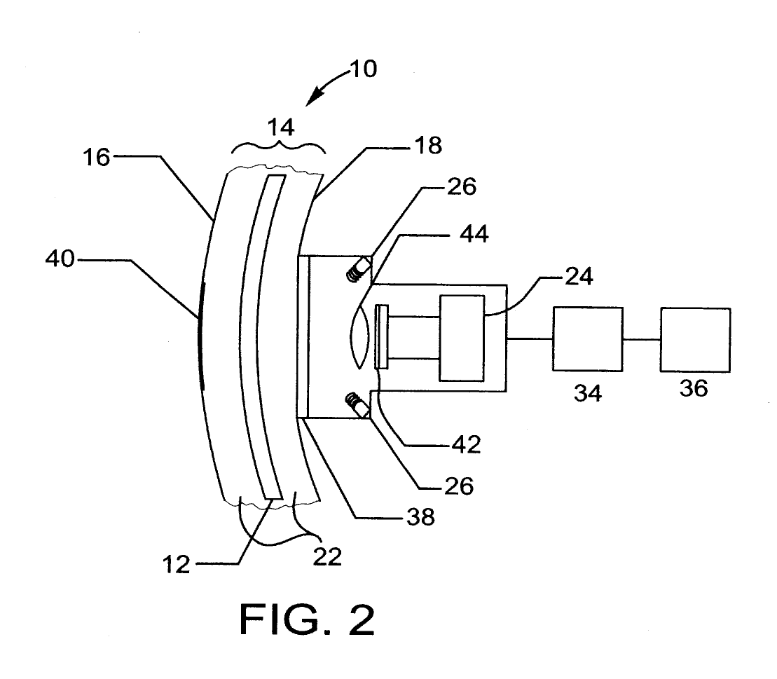

In a second and preferred embodiment of the invention, as illustrated in FIG. 2, a tempered glass panel 12 is disposed in a molding cavity 20 of one of the stationary or the movable part (16,18) of a two-part encapsulation die 14. On a surface of the mold cavity 20 of the stationary or movable mold part (16,18) in which the tempered glass panel 12 is disposed, an area 40 having diffuse reflection properties, for example, a matte finish paint applied thereto, is located. In the other part of the two-part encapsulation die 14 than the one in which the tempered glass panel 12 is disposed, at least the following components are disposed: a tempered glass panel viewing widow, preferably a quartz viewing window 38, at least one video device 24 oriented so as to be able to record images 28 of the tempered glass panel 12 through the quartz viewing window 38 disposed in the molding cavity 20, and at least one light source 26 to illuminate a predetermined portion of the tempered glass panel 12.

Some light beams from the at least one light source 26 will be transmitted through the tempered glass panel 12, the amount of light transmission being dependent on the type of glass from which the tempered glass panel 12 is made. Such glasses may be substantially clear glass allowing 90% or more of visible light to be transmitted therethrough. Alternatively, they may be a typical solar control automotive glass, such as EZ-KOOL glass sold by Pilkington Group Limited, which has a visible light transmittance slightly above 70%, or they may be a so-called privacy-type automotive glass such as that sold by Pilkington Group Limited under the name GALAXSEE, which has a visible light transmittance on the order of 25% or less. To provide uniform illumination of the surface of the molding cavity 20 behind the illuminated portion of the tempered glass panel 12, as mentioned previously, it may be desirable to dispose a diffusely reflective material on a predetermined area 40 thereof, for example, a matte finish paint. A white matte finish paint or, in some applications, a fluorescent matte finish paint may be considered. In a preferred configuration, a fluorescent matte finish paint which fluoresces monochromatically is utilized.

The at least one video device 24 may be a video camera capable of recording at least 25 high resolution images/sec of the tempered glass panel 12, and the at least one light source 26 may be a LED lamp having a rating between 500 mcd and 10,000 mcd and having a dominant wavelength between 380 nm and 1050 nm.

In another configuration of the second and preferred embodiment of the invention, in order to further reduce the possibility of glare due to light reflected from surfaces of, for example, the quartz viewing window 38 and/or the tempered glass panel 12, which may interfere with the clarity of the images 28 recorded by the at least one video device 24 and to improve performance of the operation of the system of the invention when typical automotive solar control glasses or privacy-type glass are utilized, it may be desirable to implement one or more of the following measures:
(1) the at least one light source 26 may be in the “long” ultraviolet (UV) portion of the spectrum, for example, 380-410 nm such as is generated by typical ultraviolet LED lights;
(2) a lens 44, preferably having a double-convex configuration for facilitating extremely close focus, may be disposed between the at least one video device 24 and the quartz window 38;
(3) an ultraviolet light blocking filter 42 may be disposed between the at least one video device 24 and the quartz window 38, or if utilized, between the at least one video device 24 and the double convex lens 44.

In a preferred configuration of the second and preferred embodiment, the LED light sources emit long-wave UV light, such as in the 380-410 nm range. The predetermined area 40 in the molding cavity 20 on which matte fluorescent paint is applied, which paint fluoresces monochromatically, for example orange, when excited by 380-410 nm UV light, provides diffuse backlighting of the tempered glass panel 12, thus reducing unwanted glare or reflection of the light emitted by the at least one light source 26. Additional reduction in glare/enhancement of the image 28 recorded by the at least one video device 24 may be accomplished by placement of a UV light blocking filter 42 immediately in front of the video camera lens which passes only the desired monochromatically colored light from the fluorescent paint. This configuration has been found to be especially useful when privacy-type glasses comprise the tempered glass panel 12. By way of contrast, if a visible light source and a white matte painted area were utilized with a privacy-type glass, the reflected glare has been calculated to be about 2.8 times as intense as the light transmitted through the tempered glass panel 12, rendering image analysis difficult and unreliable.

As with the first embodiment of the invention described previously herein in the second and preferred embodiment, the at least one image 28 of the tempered glass panel 12 recorded by the at least one video device 24 is electronically transmitted to the computer 34 on which the dedicated software previously described has been installed. Analysis of the recorded images 28 again takes place in real time, and if a sudden change in the appearance of the tempered glass panel 12 occurs, an electronic signal is sent to an encapsulation process control device 36 to abort the encapsulation process. The process is aborted in 0.1 sec or less.

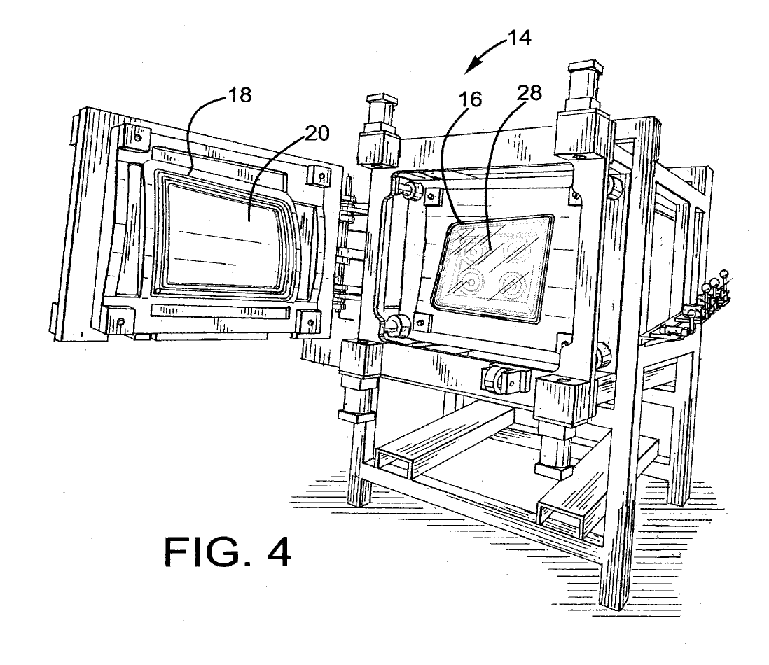

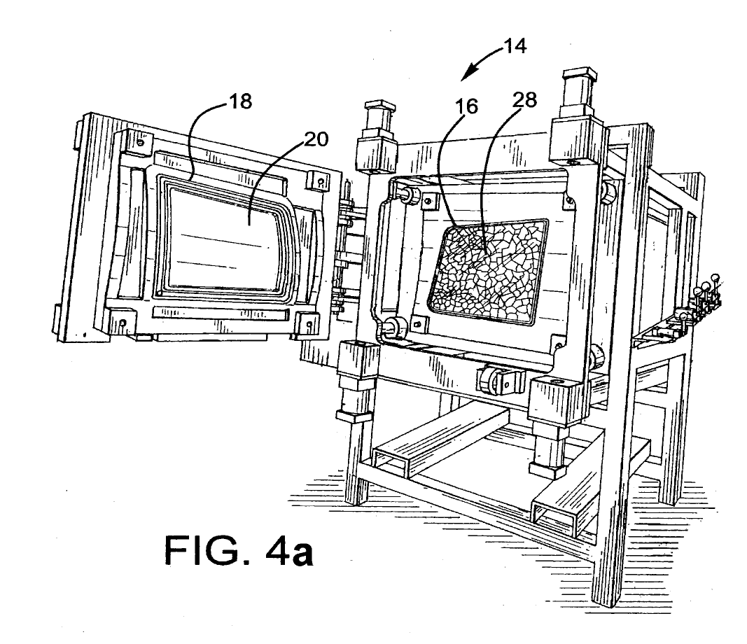

FIGS. 4 and 4a show an intact tempered glass panel 12 and a broken tempered glass panel 12, respectively, in the encapsulation die 14, as such glass panels would be viewed by the at least one video device 24.

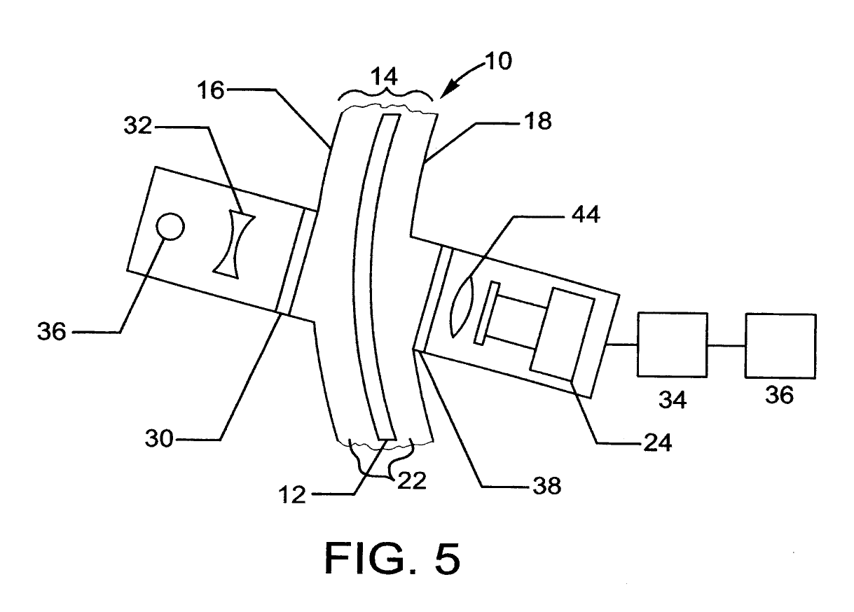

FIG. 5 illustrates a variation of the first embodiment of the invention, as illustrated in FIG. 1. It will be observed in FIG. 1, that the at least one video device 24 and the at least one light source 26 are positioned substantially normally to tempered glass panel 12. While the configuration of FIG. 1 provides a relatively high resolution image of the cracks in tempered glass panel 12 when it breaks, it has been found that the non-normal arrangement shown in FIG. 5 further enhances the image of the cracks in the broken glass panel 12. This may be especially helpful for dark tinted glasses which transmit, for example, 20% or less of incident light. This arrangement may also be useful with very thin glasses.

In any of the embodiments and variations thereof, the dedicated software accomplishes its various functions, including high speed analysis of the one or more recorded images 28, by one or more algorithms which preferably:
(1) detect sudden changes in appearance of the tempered glass panel 12, for example, the appearance of one or more cracks in the glass panel 12;
(2) if an optional polarizing device, or devices, for example polarizing filters, are utilized, detects rapid changes in the appearance of birefringence rings; and
(3) records a reference image at the beginning of each molding cycle, thus reducing the likelihood of the analysis of the subsequent images 28 recorded during that molding cycle being adversely affected by the accumulation of dirt, molding material or other obscuring substance on, for example the quartz viewing window 38, although other algorithms may also be useful in connection with the invention.

In accordance with the provisions of the patent statutes, the present invention has been described in what is considered to represent its preferred embodiments. However, it should be noted that the invention can be practiced otherwise than as specifically illustrated and described without departing from its spirit or scope.

What is claimed is:

1. An apparatus for detecting glass breakage during a process for encapsulating a tempered glass panel comprising:
a two-part encapsulation die having a molding cavity formed in at least one part thereof;
at least one video device disposed in one part of the encapsulation die and oriented so as to be able to record at least one image of at least a portion of the molding cavity when the two parts of the encapsulation die are in closed molding contact;
at least one light source disposed in one part of the encapsulation die and capable of illuminating the portion of the molding cavity to allow the at least one video device to record at least one image thereof when the two parts of the encapsulation die are in closed molding contact;
a computer having installed therein, dedicated software for at least:
high-speed analysis of at least one image of the tempered glass panel recorded by the at least one video device;
recognition of breakage of the tempered glass panel; and
transmittal of electronic signals indicating such breakage of the tempered glass panel to an encapsulation process control device;
one or more electronic devices to transmit the video signals recorded by the at least one video device to the computer; and
one or more electronic devices to transmit the electronic signals from the computer to the encapsulation process control device.

2. The apparatus defined in claim 1, wherein the at least one video device comprises a video camera.

3. The apparatus defined in claim 2, wherein the at least one video camera will fit within a cube 15-25 mm on each edge.

4. The apparatus defined in claim 1, wherein the at least one light source comprises an LED light having a dominant wavelength between 380 nm and 1050 nm.

5. The apparatus defined in claim 1, wherein the encapsulation die is made from aluminum or steel.

6. A method for detecting glass breakage during a tempered glass encapsulation process comprising:
providing a two-part encapsulation die comprising a first part and a second part;
disposing a tempered glass panel in a molding cavity formed in one of the first and second parts of the two-part encapsulation die, the two-part encapsulation die having at least one video device and at least one light source;
bringing the first and second parts of the encapsulation die into intimate contact to form at least one encapsulation chamber;
activating the at least one video device and the at least one light source, so that light beams emitted by the light source illuminate the glass panel to a level sufficient for the at least one video device to record one or more images of the glass panel;
initiating injection of one or more polymeric materials into desired portions of the encapsulation chamber so that the polymeric material is directed into molding contact with one or more desired portions of the glass panel;
recording one or more images of the tempered glass panel via the at least one video device;
providing a computer having installed therein dedicated software for analyzing the one or more images of the tempered glass panel on a real-time basis;
transmitting the one or more images recorded by the at least one video device to the computer;
analyzing the one or more recorded images on a real-time basis;
transmitting electronic control signals from the computer to an encapsulation process control device, wherein if analysis of the images shows the tempered glass panel is unbroken, the encapsulation process is allowed to proceed, but if the tempered glass panel is broken, within 0.1 seconds or less of detection of glass breakage, the encapsulation process is aborted.

7. The method defined in claim 6, wherein the at least one video device and the at least one light source are disposed in the first part of the encapsulation die.

8. The method defined in claim 6, wherein the at least one video device is disposed in the first part of the encapsulation die, and the at least one light source is disposed in the second part of the encapsulation die.

9. The method defined in claim 6, wherein the at least one video device and the at least one light source is disposed in the second part of the encapsulation die.

10. The method defined in claim 6, wherein if the tempered glass panel is broken, the encapsulation process is aborted in 0.04 seconds or less.

11. A method for detecting glass breakage during a tempered glass encapsulation process comprising:
providing a two-part encapsulation die comprising a movable part and a stationary part;
disposing a tempered glass panel in a molding cavity formed in at least one of the movable part or the stationary part of the two-part encapsulation die, the molding cavity having at least one video device and at least one light source;
bringing the movable part and the stationary part of the encapsulation die into intimate contact to form an encapsulating chamber, wherein light transmitted by the at last one light source is transmitted through a light transmitting portion of the glass panel and is detected by the at least one video device, enabling the at least one video device to record a substantially continuous series of images close in time to one another, of the glass panel;
initiating injection of one or more polymeric materials into desired portions of the encapsulation chamber so that the polymeric material is directed into molding contact with the desired portion of the glass panel;
providing a computer, having installed therein dedicated software for analyzing the series of images of the tempered glass panel on a real-time basis;
transmitting the series of images recorded by the at least one video device to the computer;
analyzing the series of images of the glass panel on a real-time basis;
transmitting electronic control signals from the computer to an encapsulation process control device, wherein if analysis of the images shows the tempered glass panel is unbroken, the encapsulation process is allowed to proceed, but if the tempered glass panel is broken, within 0.1 seconds or less of detection of glass breakage, the encapsulation process is aborted.

12. The method defined in claim 11, wherein the at least one video device and the at least one light source are both disposed in one of the stationary part of the two-part encapsulation die and the movable part of the two-part encapsulation die.

13. The method defined in claim 11, wherein the polymeric material is one chosen from the group consisting of: PVC, thermoplastic elastomers (TPEs) and polyurethanes.

14. The method defined in claim 11, wherein the continuous series of images of the tempered glass panel is recorded by the at least one video device at a rate of 25 images/sec. or greater.

15. The method defined in claim 11, wherein a light diffusing element is disposed between the at least one light source and the tempered glass panel.

16. The method defined in claim 11, wherein the encapsulation process comprises an injection molding process.

17. The method defined in claim 11, wherein the encapsulation process control device comprises a programmable logic controller.

18. The method defined in claim 11, wherein if the tempered glass panel is broken, the encapsulation process is aborted in 0.04 seconds or less.

19. A method for detecting glass breakage during a tempered glass encapsulation process comprising:
providing a two-part encapsulation die comprising a movable part and a stationary part;
disposing a tempered glass panel in a molding cavity formed in at least one of the movable part or the stationary part of the two-part encapsulation die, a predetermined portion of the surface of the molding cavity having a diffusely reflective material disposed thereon;
disposing at least one video device and at least one light source together in the one of the movable part or the stationary part of the encapsulation die other than the one in which the tempered glass panel is disposed;
bringing the movable part and the stationary part of the encapsulation die into intimate contact to form an encapsulation chamber, wherein light beams emitted by the at least one light source are transmitted, first through a viewing window and then through a light transmitting portion of the tempered glass panel to diffusely illuminate the tempered glass panel and are non-glaringly reflected back through the glass panel and the viewing window to be detected by the at least one video device, enabling the at least one video device to record a substantially continuous series of images close in time to one another, of the glass panel;
initiating injection of one or more polymeric materials into desired portions of the encapsulation chamber so that the polymeric material is directed into molding contact with the desired portion of the glass panel;
providing a computer, having installed therein dedicated software for analyzing the series of images of the tempered glass panel on a real-time basis;
transmitting the series of images recorded by the at least one video device to the computer;
analyzing the series of images of the glass panel on a real-time basis;
transmitting electronic control signals from the computer to an encapsulation process control device, wherein if analysis of the images shows the tempered glass panel is unbroken, the encapsulation process is allowed to proceed, but if the tempered glass panel is broken, within 0.1 seconds or less, the encapsulation process is aborted.

20. The method defined in claim 19, wherein the diffusely reflective material comprises a fluorescent matte finish paint.

21. The method defined in claim 19, wherein a double-convex lens is disposed between the at least one video device and the quartz window.

22. The method defined in claim 19, wherein an ultraviolet light blocking filter is disposed between the double-convex lens and the at least one video device.

23. The method defined in claim 19, wherein the ultraviolet light source has a dominant wavelength between 380 nm and 410 nm.

24. The method defined in claim 20, wherein the fluorescent matte finish paint fluoresces monochromatically.
